(19) United States
(12) Patent Application Publication
(10) Pub. No.: US 2009/0066453 A1
(43) Pub. Date: Mar. 12, 2009

(54) CHOKE OF ELECTRIC DEVICE

(75) Inventors: Timo KOIVULUOMA, Vantaa (FI); Henri Kinnunen, Veikkola (FI); Jukka Sikanen, Sulkava (FI)

Correspondence Address: BUCHANAN, INGERSOLL & ROONEY PC, POST OFFICE BOX 1404, ALEXANDRIA, VA, 22313-1404, US

(73) Assignee: ABB OY, Helsinki (FI)

(21) Appl. No.: 12/199,096

(22) Filed: Aug. 27, 2008

(30) Foreign Application Priority Data
Sep. 7, 2007 (FI) 20075617

(51) Int. Cl. H01F 27/08

(52) U.S. Cl. 336/60

(57) ABSTRACT

The present invention relates to a choke (1) of an electrical device, comprising at least one conductor (2, 3) wound into a coil having separate turns of the conductor wound on top of one another, and a cooling element (4) for cooling the choke. In order to achieve efficient cooling without electrical properties of the choke being impaired, the cooling element (4) is arranged against the coil to cool the conductor (2, 3), wound into a coil, of the choke by means of a medium flowing in a direction parallel to the conductor (2, 3) through a cooling channel provided in the cooling element.

### FIELD OF THE INVENTION

The present invention relates to cooling a coil of a choke by means of a cooling element.

### DESCRIPTION OF PRIOR ART

A heat load generated in a choke of an electronic device due to losses has to be eliminated from the choke in order to prevent the temperature of the choke from rising too much.

A prior art solution for cooling a choke is to arrange a cooling element in connection with the choke such that the cooling element is arranged into contact with a coil of the choke. The cooling element may then be located in connection with the core of the choke or between layers of a conductor that has been wound into a coil. In these known solutions, a cooling fluid is fed through the cooling element via a cooling channel provided in the cooling element. In such a case, the cooling fluid flows in the cooling channel in a direction which is practically almost perpendicular to the longitudinal direction of the conductor wound into a coil.

However, the aforementioned prior art solution involves the problem that in practice it has been difficult to produce a sufficient cooling power without electrical properties of the choke being subsequently impaired.

### SUMMARY OF THE INVENTION

An object of the present invention is to alleviate the above-described problem and to provide a novel choke structure which enables the choke to be provided with the necessary cooling without the electrical properties of the choke being subsequently impaired. This object is achieved by a choke of an electronic device according to claim 1.

The invention utilizes a cooling element which is arranged against a coil and provided with a cooling channel to enable a cooling medium to be fed therethrough in a direction parallel to a conductor of the coil. Such a structure enables a considerable contact surface to be provided between the coil and the cooling element such that the contact surface enables a heat load being generated to be efficiently transferred to the flowing medium without the electrical properties of the choke being impaired.

Preferred embodiments of the choke according to the invention are disclosed in the dependent claims.

### BRIEF DESCRIPTION OF THE FIGURES

In the following, the invention will be described in closer detail and with reference to the accompanying figures, in which

FIGS. 1 and 2 show a first preferred embodiment of a choke according to the invention,

FIG. 3 shows a second preferred embodiment of the choke according to the invention, and

FIG. 4 shows a third preferred embodiment of the choke according to the invention.

### DESCRIPTION OF AT LEAST ONE EMBODIMENT

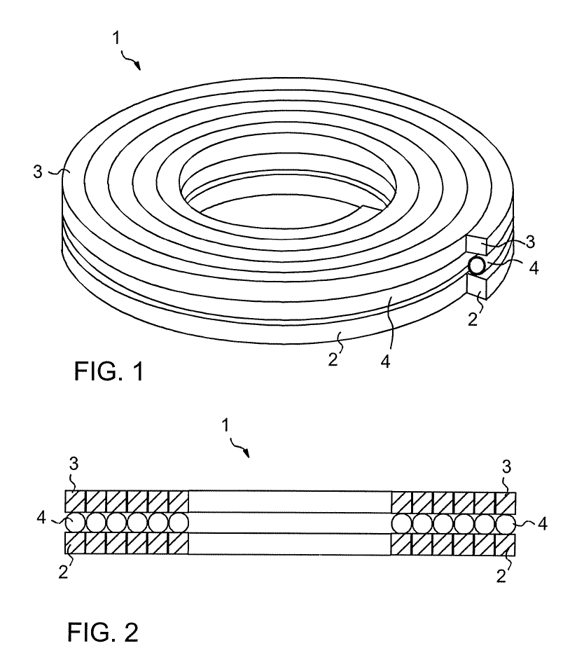

FIGS. 1 and 2 show a first preferred embodiment of a choke according to the invention. FIG. 1 shows such a choke 1 as viewed obliquely from above, while FIG. 2 shows a cross-section thereof.

The choke 1 comprises at least one conductor 2 wound into a coil such that separate turns of the conductor 2 are wound on top of one another. FIGS. 1 and 2 show two conductors 2, 3 wound into a coil, and a cooling element 4 arranged between coils formed by these conductors.

The cooling element 4 is provided with a cooling channel through which a medium for cooling the coil is fed and which, in this example, is formed by a tube wound into a coil and arranged to extend along the conductors 2, 3. The cooling medium is thus made to flow in a direction parallel to the conductors.

The arrangement of FIGS. 1 and 2 enables the cooling element 4 to come into contact with the conductors 2, 3 practically almost over the entire length of the conductor. The large contact surface area enables a heat load generated in the coils due to losses to be dissipated efficiently by means of the medium flowing through the cooling element 4.

In the embodiment of FIGS. 1 and 2, the cooling element 4 may be manufactured from a plastic tube which is wound into a coil. In such a case, no separate electrical insulation is necessary between the cooling element and the conductor and, further, the cooling element becomes relatively simple to manufacture since the plastic tube is easy to deform appropriately. As distinct from the example shown in the figures, the plastic tube may also continue to the outer surface of the coil in order to achieve an even more efficient cooling.

The thermal conductivity of a plastic tube is relatively poor. Consequently, as large a contact surface area as possible is to be provided between the plastic tube and a conductor to be cooled. Such a larger contact surface area may be achieved by designing the conductor and the plastic tube to match one another, i.e. for instance such that when using a rectangular conductor similar to that shown in FIGS. 1 and 2, a surface of the plastic tube coming into contact with the conductor is made planar. A possibility is to during manufacture suck a vacuum in a flexible plastic tube when a coil and a cooling element are arranged against one another. Alternatively, empty spaces between the conductor and the tube may be filled with an electrical insulation material which is thermally highly conductive (e.g. an epoxy) so as to achieve as large a contact surface area as possible.

Instead of a plastic material, the cooling element 4 may be manufactured from a metal material, which has a better thermal conductivity than plastic. In such a case, the cooling element is more difficult to manufacture but cooling becomes more efficient. In connection with an electrically conductive cooling element, an insulation material is to be arranged between the cooling element and the coil. Nevertheless, the electrically conductive cooling element affects the electrical properties of the choke 1. At high frequencies, eddy currents are induced into electrically conductive cooling materials. This is observable already at frequencies of less than 1 kHz. At higher frequencies the eddy currents reduce the inductance of the choke. At the same time, the metal suffers from eddy current losses, which increases the cooling power demand. An electrically conductive material should be avoided in the core of a coil where the density of a magnetic flux is at its highest, because the impairing influence it has on the electric values of the choke is at its strongest therefrom.

In accordance with the invention, the material of the cooling element 4 is selected preferably according to the purpose of use, in practice the frequency, of the choke 1. At a frequency of 50 Hz the inductance of the choke of FIGS. 1 and 2 is approximately 5.4 μH when the cooling element is manufactured from plastic, and approximately 5.0 μH when the cooling element is manufactured from aluminum. At low frequencies, the cooling element may thus be manufactured from electrically conductive materials without the electrical properties of the choke being significantly impaired. For example, the currents of an input choke of a frequency converter are low-frequency ones, so the cooling element of the input choke may be manufactured from an electrically conductive metal material. However, the situation is different at higher frequencies. At a frequency of 100 kHz the inductance of the choke of FIGS. 1 and 2 is approximately 3.7 μH when the cooling element is manufactured from plastic, and approximately 0.5 μH when the cooling element is manufactured from aluminum. Hence, the use of electrically conductive materials in a cooling element should be avoided at higher frequencies. For instance the frequencies of an output choke of a frequency converter are such that the cooling element is manufactured preferably from a material which is not electrically conductive, such as an appropriate plastic or ceramic.

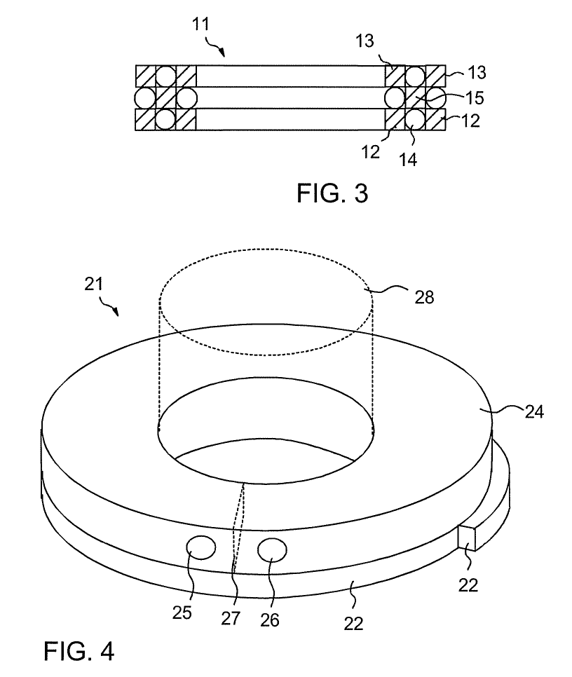

FIG. 3 shows a second preferred embodiment of the choke according to the invention. The embodiment of FIG. 3 is highly similar to that of FIGS. 1 and 2; consequently, the embodiment of FIG. 3 will be described in the following mainly by revealing differences between these embodiments.

In FIG. 3, a choke 11 is shown in cross-section in a manner similar to that shown in FIG. 2. However, in order to achieve a higher cooling power, tubes 14 forming a cooling element 14 are arranged differently in relation to conductors 12, 13, and 15 forming coils. Hence, the conductors are cooled from a plurality of directions.

FIG. 4 shows a third preferred embodiment of the choke according to the invention. The embodiment of FIG. 4 is highly similar to that of FIGS. 1 and 2; consequently, the embodiment of FIG. 4 will be described in the following mainly by revealing differences between these embodiments.

In the embodiment of FIG. 4, a conductor 22, wound into a coil, of a choke 21 is cooled by a cooling element 24 formed by a ring. As distinct from FIG. 4, it is conceivable that a second conductor wound into a coil is arranged also above the cooling element 24 to be cooled by the same cooling element 24 used for cooling the conductor 22.

The cooling element 24 of FIG. 4 formed by a ring has a shape of a disc having an opening in the center thereof. According to the previous embodiments, the cooling element 24 may be manufactured from plastic or metal. In connection with metal in particular, this embodiment is preferable since it makes it unnecessary to wind a metal tube into a coil.

A cooling medium is fed to the cooling element via a feed opening 25 and, similarly, the cooling medium is discharged from the cooling element 24 via a discharge opening 26. A wall 27 arranged inside the cooling element and shown in broken lines is provided to ensure that the cooling medium circulates through the entire ring in a direction parallel to the conductor 22 prior to being discharged from the cooling element 24. Thus, the conductor 22 forming a coil comes into contact with the cooling element almost over its entire length, which results in efficient cooling.

In FIG. 4, an iron core 28 of a choke is illustrated in broken lines. Depending on the implementation, such an iron core may be used in the embodiment of FIG. 4 or, alternatively, it may be omitted. The same applies to other embodiments of the invention, i.e. they may also be implemented with a core or without a core (an air core). When using a core, it may be manufactured from any material suitable for use in the core of a choke.

It is to be understood that the above description and the related figures are only intended to illustrate the present invention. It will be apparent to a person skilled in the art that the invention may be varied and modified in many ways without deviating from the scope of the invention.

1. A choke of an electrical device, comprising
at least one conductor wound into a coil having separate turns of the conductor wound on top of one another, and
a cooling element for cooling the choke, wherein the cooling element is formed by an elongated tube and wound into a coil in which the tube extends along said at least one conductor wound into a coil and in which separate turns of the tube are wound on top of one another, is arranged against the coil to cool the conductor, wound into a coil, of the choke by means of a medium flowing in a direction parallel to the conductor through a cooling channel provided in the cooling element.

2. A choke as claimed in claim 1, wherein the cooling element is manufactured from a plastic or ceramic material.

3. A choke as claimed in claim 2, wherein the choke is an output choke of a frequency converter.

4. A choke as claimed in claim 1, wherein the cooling element is manufactured from metal.

5. A choke as claimed in claim 2, wherein the choke is an input choke of a frequency converter.

6. A choke as claimed in claim 1, wherein the choke is a choke with an air core.

7. A choke as claimed in claim 1, wherein the choke comprises an iron core.
